(19) United States
(12) Patent Application Publication
(10) Pub. No.: US 2006/0281006 A1
(43) Pub. Date: Dec. 14, 2006

(54) Lithium secondary battery

(76) Inventors: Akiko Fujino, Suita-shi (JP); Tsumoru Ohata, Kyoto-shi (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 10/555,447

(22) PCT Filed: Nov. 16, 2004
(86) PCT No.: PCT/JP04/16986

§ 371 Date: Nov. 3, 2005

(30) Foreign Application Priority Data
Jan. 5, 2004 (JP) 2004-000082

(51) Int. Cl. H01M 2/16

(52) U.S. Cl. 429/246; 429/144; 429/254

(57) ABSTRACT

A lithium secondary battery includes: a positive electrode comprising a composite lithium oxide; a negative electrode comprising a material capable of absorbing and desorbing lithium; a separator interposed between the positive electrode and the negative electrode; and a non-aqueous electrolyte. The separator comprises non-woven fabric. At least one of the positive electrode and the negative electrode has a porous film that is adhered to a surface thereof, and the porous film comprises an inorganic oxide filler and a binder. The non-woven fabric preferably has a thickness of not less than 15 μm and not more than 50 μm. The non-woven fabric preferably has a melt-down temperature of 150° C. or more.

### TECHNICAL FIELD

The present invention relates to a lithium secondary battery including: a positive electrode comprising a composite lithium oxide; a negative electrode comprising a material capable of absorbing and desorbing lithium; a separator interposed between the positive electrode and the negative electrode; and a non-aqueous electrolyte. This lithium secondary battery is excellent in cycle life, short-circuit prevention ability and safety, as well as being inexpensive.

### BACKGROUND ART

Chemical batteries, such as lithium secondary batteries (lithium ion secondary batteries), are equipped with a separator that has the functions of electrically insulating the positive electrode from the negative electrode, and retaining a non-aqueous electrolyte.

Lithium secondary batteries currently use a microporous film composed of a polyolefin resin, such as polyethylene or polypropylene, as the separator. The microporous film is usually produced by drawing a sheet that is obtained by a molding method, such as extrusion.

However, the microporous film usually has a low porosity and therefore a low ability to retain a non-aqueous electrolyte. Hence, the battery internal resistance tends to rise. Particularly when a battery is repeatedly charged and discharged and its electrodes become thicker due to expansion and contraction of the active materials, such electrodes are not supplied with a sufficient amount of a non-aqueous electrolyte, because of the low electrolyte-retaining ability of the microporous film. As a result, the capacity tends to lower due to electrolyte depletion.

A lithium secondary battery using a separator made of non-woven fabric, which is inexpensive and has a high ability to retain a non-aqueous electrolyte, instead of the separator made of a microporous film has also been proposed. Non-woven fabric is usually produced by putting fibers together without weaving them.

However, non-woven fabric has a poor mechanical strength. Thus, dendrites produced by repetitive charge and discharge easily penetrate the non-woven fabric, thereby causing the positive electrode and the negative electrode to short-circuit. As a result, a long cycle life cannot be expected. Also, in comparison with the use of a microporous film, the use of non-woven fabric increases the risk of short-circuits resulting from the adhesion of an electrode mixture that has fallen off in a manufacturing process or foreign matter that has been undesirably included to electrode surfaces, thereby resulting in a decrease in production yields.

Also, the microporous film and the non-woven fabric have the following points in common.

In the event of an internal short-circuit or in the event that a battery is penetrated by a sharp protruding object such as a nail, the microporous film and the non-woven fabric may be broken due to heat instantaneously generated by short-circuit reaction. Such breakage causes the short-circuit to expand, generates more reaction heat, and promotes abnormal overheating of the battery. Further, when a battery is exposed to high temperatures of 150° C. or more, the microporous film or non-woven fabric shrinks or melts. Consequnetly, the electrode group (particularly wound-type electrode group) is distorted, which may result in a short-circuit between the positive and negative electrodes and therefore an abnormal overheating.

Also, there has been proposed a technique (related art 1) of using a non-woven fabric as the separator and forming a polyvinylidene fluoride (hereinafter “PVDF”) layer on an electrode surface (Japanese Laid-Open Patent Publication No. 2001-176497). The related art 1 is aimed at enhancing the ability to retain a non-aqueous electrolyte and preventing an internal short-circuit.

However, at high temperatures, the PVDF layer is swollen with the non-aqueous electrolyte or dissolved in the non-aqueous electrolyte. Thus, at such high temperatures as to cause heat shrinkage of the separator, the PVDF layer is dissolved in the electrolyte, thereby causing the electrodes to short-circuit, which inevitably results in heat runaway. Further, since the PVDF layer has no pores, its electrolyte-retaining ability is low, which is a cause of an increase in battery internal resistance.

Further, regarding a battery that uses a microporous film as a separator, there have been proposed a technique (related art 2) of using a porous film, comprising solid particles and a binder, as the protective film of the electrode surface and a technique (related art 3) of using non-woven fabric as the protective film of the electrode surface (Japanese Laid-Open Patent Publication No. Hei 7-220759).

However, since the related art 2 uses the microporous film having a low ability to retain a non-aqueous electrolyte as the separator, it cannot reduce internal resistance or improve cycle life. Also, the related art 3 is substantially the same as the use of two separators in layers. However, since the use of very thin separators in layers is difficult in terms of the manufacturing process, the use of thick separators becomes necessary, inevitably resulting in a decrease in battery capacity.

### DISCLOSURE OF THE INVENTION

Problem that the Invention Is to Solve

It is therefore an object of the present invention to reduce the internal resistance of a lithium secondary battery, improve its cycle life, and suppress abnormal overheating and an internal short-circuit which occurs mainly during production.

Means for Solving the Problem

The present invention reduces the internal resistance of a lithium secondary battery and improve its cycle life by using non-woven fabric as the separator. Also, by adhering a predetermined porous film to an electrode surface, the present invention prevents abnormal overheating and occurrence of an internal short-circuit mainly during production.

That is, the present invention is a lithium secondary battery including: a positive electrode comprising a composite lithium oxide; a negative electrode comprising a material capable of absorbing and desorbing lithium; a separator interposed between the positive electrode and the negative electrode; and a non-aqueous electrolyte, and has the following characteristics.

First, the separator comprises non-woven fabric. Since non-woven fabric is highly capable of retaining a non-aqueous electrolyte, it suppresses electrolyte shortage (electrolyte depletion) upon charges and discharges, thereby improving the cycle life of the battery. Also, since non-woven fabric is inexpensive, it permits low-cost production of the battery. As used herein, non-woven fabric refers to a sheet of fibers produced by putting fibers together without weaving them.

The thickness of the non-woven fabric used as the separator is desirably not less than 15 μm and not more than 50 μm. When the thickness of the non-woven fabric is not less than 15 μm, the non-woven fabric can retain a sufficient amount of a non-aqueous electrolyte. Also, when the thickness of the non-woven fabric is not more than 50 μm, the balance between battery design capacity and battery characteristics can be maintained favorably.

The non-woven fabric used as the separator desirably has a melt-down temperature of 150° C. or more. The melt-down temperature as used herein refers to the temperature at which the fibers of non-woven fabric melt down and adhere to one another. The melt-down temperature of 150° C. or more reduces the probability of deformation of the separator upon exposure of the battery to high temperatures, thereby enhancing battery safety.

The non-woven fabric is desirably made of at least one selected from the group consisting of polypropylene, polyamide, polyimide and polyethylene terephthalate, because of, for example, their good thermal stability.

Next, at least one of the positive electrode and the negative electrode has a porous film adhered to at least the surface facing the other electrode. The porous film comprises an inorganic oxide filler and a binder.

When at least one of the positive electrode and the negative electrode has the porous film adhered to the surface, a short-circuit can be avoided even if foreign matter or an electrode mixture that has fallen off adheres to the electrode surface during production and penetrates the non-woven fabric separator. Hence, even if non-woven fabric that is more coarse than a microporous film is used as the separator, a decrease in production yields due to short-circuits during production can be suppressed. Also, even if a sharp protruding object, such as a nail, penetrates the battery and the heat of several hundreds ° C. generated by short-circuit reaction damages the separator, the porous film can retain the shape. As a result, expansion of the short-circuit is suppressed, and heat runaway can be avoided.

The present invention includes a case where the porous film is adhered only to the positive electrode surface(s), a case where the porous film is adhered only to the negative electrode surface(s), and a case where the porous film is adhered to both the positive electrode surface(s) and the negative electrode surface(s). Among them, the case where the porous film is adhered only to the negative electrode surface(s) is preferable.

Generally, the positive electrode is composed of a belt-like positive electrode current collector with a positive electrode mixture layer carried on each side thereof, and the negative electrode is composed of a belt-like negative electrode current collector with a negative electrode mixture layer carried on each side thereof. Thus, when the porous film is adhered to the negative electrode surface, the porous film is desirably formed so as to completely cover the negative electrode mixture layer carried on each side of the negative electrode current collector. Also, when the porous film is adhered to the positive electrode surface, the porous film is desirably formed so as to completely cover the positive electrode mixture layer carried on each side of the positive electrode current collector.

In terms of suppressing abnormal overheating and an internal short-circuit, a thicker porous film is more preferable, but if it is too thick, the battery characteristics deteriorate. Therefore, in consideration of the balance between battery safety and battery performance, the thickness of the porous film is desirably not less than 0.5 μm and not more than 20 μm.

The binder of the porous film desirably comprises at least a polymer having an acrylonitrile group. Also, the inorganic oxide filler preferably comprises alumina.

Since a polymer having an acrylonitrile group is highly resistant to heat and hardly decomposed even at high temperatures, it is advantageous in maintaining the structure of the porous film. Also, a polymer having an acrylonitrile group has a good binding capability, thereby enabling the formation of a porous film of high strength even if a small amount thereof is used relative to the amount of the inorganic oxide filler.

In terms of maintaining the good balance between the strength of the porous film and its ability to retain the non-aqueous electrolyte, the content of the inorganic oxide filler in the porous film is preferably not less than 50% by weight and not more than 99% by weight, more preferably not less than 90% by weight and not more than 99% by weight.

### EFFECTS OF THE INVENTION

According to the present invention, the use of non-woven fabric as the separator in a lithium secondary battery makes it possible to reduce internal resistance and improve cycle life. Also, the adhesion of a predetermined porous film to an electrode surface enables prevention of abnormal overheating and occurrence of an internal short-circuit resulting from undesirable inclusion of foreign matter or separated electrode mixture mainly during production. Further, the materials of the porous film and the non-woven fabric are inexpensive. Accordingly, the present invention can provide a lithium secondary battery that is excellent in cycle life, short-circuit prevention ability and safety at low costs.

### BRIEF DESCRIPTION OF DRAWINGS

FIG. 1 is a schematic cross-sectional view showing the configuration of electrodes of a lithium secondary battery according to the present invention.

### BEST MODE FOR CARRYING OUT THE INVENTION

Referring now to a drawing, embodiments of the present invention are described.

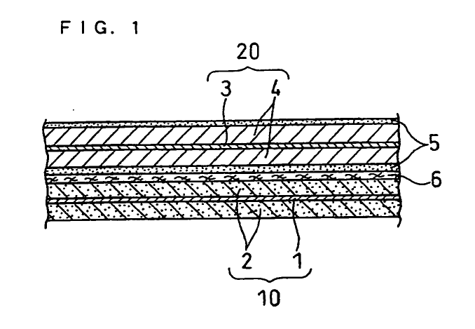

FIG. 1 is a diagram showing the arrangement of a positive electrode 10, a negative electrode 20, porous films 5 and a separator 6 in an electrode group of a lithium secondary battery (lithium ion secondary battery) according to one embodiment of the present invention. In this embodiment, the porous films 5 are adhered to the surfaces of only the negative electrode 20, but they can be adhered to the surfaces of only the positive electrode 10, or adhered to the surfaces of both the positive electrode 10 and the negative electrode 20.

The positive electrode 10 comprises a positive electrode current collector 1 and positive electrode mixture layers 2 carried thereon. The positive electrode mixture layers 2 contain a positive electrode active material comprising a composite lithium oxide. Also, the negative electrode 20 comprises a negative electrode current collector 3 and negative electrode mixture layers 4 carried thereon. The negative electrode mixture layers 4 contain a material capable of absorbing and desorbing lithium. The separator 6 is interposed between the positive electrode 10 and the negative electrode 20.

One characteristic of the present invention lies in the use of non-woven fabric as the separator 6. A separator made of non-woven fabric is highly capable of retaining a non-aqueous electrolyte, compared with a separator made of a microporous film. Thus, the electrolyte shortage upon charges and discharges is suppressed, and the cycle characteristics of the battery is improved.

Also, another characteristic of the present invention is that the porous films are adhered to the surfaces of the positive electrode and/or the negative electrode. Each porous film comprises an inorganic oxide filler and a binder. Since an inorganic oxide filler has a high heat resistance, the porous film is inherently resistant to deformation even at high temperatures. However, when the porous film is adhered to the separator, the separator becomes deformed due to a large amount of heat generated by an internal short-circuit, in spite of the high heat resistance of the porous film itself, and at the same time, the porous film also becomes shrunk. Thus, the porous film cannot perform the function of suppressing a short-circuit. Also, when the porous film alone is molded into sheet form and the resultant sheet is used as the separator, the sheet needs to have a considerably large thickness in terms of maintaining the strength of the sheet. This requires a large amount of a binder, thereby making it difficult to maintain battery characteristics and design capacity.

The configuration of the porous film is hereinafter described.

Various resin materials can be used as the binder of the porous film. Among them, the use of a highly heat-resistant resin material is desirable. Thus, the thermal decomposition starting temperature of the resin material observed by thermal analysis is desirably 250° C. or more.

Also, since the binder is desirably resistant to deformation at high temperatures, it is desirably amorphous or non-crystalline. Further, when the binder is crystalline, the heat deformation temperature thereof is desirably 250° C. or more.

The thermal decomposition starting temperature and thermal deformation starting temperature of the binder can be measured by differential scanning calorimetry (DSC) or thermogravimetry-differential thermal analysis (TG-DTA). For example, the starting point of weight change in TG-DTA corresponds to thermal decomposition starting temperature, and the point of inflection in DSC corresponds to heat deformation temperature.

In producing a wound-type electrode group, stress is applied to the porous film, and hence the binder is preferably elastic like rubber. Although various rubber-like polymers can be used as the binder, rubber-like polymers having an acrylonitrile group are particularly preferable, because of their good binding capability and high heat resistance. Unlike a hard porous film containing a crystalline binder, a porous film containing a rubber-like polymer as the binder is unlikely to get cracked or damaged when electrodes are wound. It is therefore possible to maintain high production yields.

The filler of the porous film is required to be resistant to heat and electrochemically stable in the environment inside the lithium secondary battery. Hence, an inorganic oxide satisfying these requirements is preferably used. Also, the porous film is formed by preparing a slurry containing a filler and a binder and applying the slurry to an electrode surface. Thus, the inorganic oxide filler is also required to be suitable for forming a slurry. Examples satisfying these requirements include alumina, titania, zirconia and magnesia. Among them, in terms of stability, costs, ease of handling, etc., alumina is preferable, and α-alumina is particularly preferable.

A mixture of a plurality of inorganic oxide fillers may be used. For example, a mixture of inorganic oxide fillers of the same kind with different median diameters provides a dense porous film. Also, a plurality of porous films containing different inorganic oxide fillers may be layered.

The content of the inorganic filler in the porous film is preferably not less than 50% by weight and not more than 99% by weight, and more preferably not less than 90% by weight and not more than 99% by weight. If the content of the inorganic oxide filler is less than 50% by weight, the binder becomes excessive, so it may become difficult to control the pore structure formed by gaps between the particles of the filler. On the other hand, if the content of the inorganic oxide filler exceeds 99% by weight, the binder becomes deficient, so that the strength of the porous film and the adhesion of the porous film to an electrode surface may lower. If the porous film falls off, the function of the porous film itself is impaired, and battery characteristics are also impaired.

With respect to the median diameter (D50: mean particle size) of the inorganic oxide filler, there is no particular limitation, but it is generally in the range of 0.1 to 5 μm, and preferably 0.2 to 1.5 μm.

With respect to the thickness of the porous film, there is no particular limitation. However, in terms of sufficiently ensuring the short-circuit prevention function of the porous film and maintaining the design capacity, it is preferably 0.5 to 20 μm, and particularly preferably 3 to 10 μm. Also, the sum of the thickness of the non-woven fabric used as the separator and the thickness of the porous film is desirably about 15 to 30 μm.

The structure of the non-woven fabric is described below.

Non-woven fabric is a sheet of fibers produced by putting fibers together without weaving them. With respect to the length and thickness of the fibers constituting the non-woven fabric, there is no particular limitation. However, in terms of ensuring the electrolyte-retaining ability, the thickness of the fibers (fiber diameter) is desirably in the range of 0.5 to 30 μm, more desirably in the range of 0.5 to 10 μm, and particularly desirably in the range of 0.5 to 5 μm.

The thickness of the non-woven fabric is desirably not less than 15 μm and not more than 50 μm, and in terms of the balance between cycle characteristics and capacity, it is particularly preferably not less than 15 μm and not more than 30 μm. By setting the thickness of the non-woven fabric to 15 μm or more, it is possible to sufficiently ensure the amount of a non-aqueous electrolyte retained by the non-woven fabric. Also, by setting the thickness of the non-woven fabric to 50 μm or less, the balance between battery design capacity and battery characteristics can be maintained favorably. Generally speaking, the density of non-woven fabric (weight per unit area: Basis Weight) is 10 to 200 μ/m², but there is no limitation to this range.

It is desirable that the non-woven fabric used as the separator have a high heat resistance and hardly heat-shrink or melt even at high temperatures. The higher the heat resistance of the non-woven fabric is, the more the distortion of the electrode group at high temperatures is suppressed, and the less the risk of an internal short-circuit becomes. Although the heat resistance of a common polyethylene microporous film is less than 150° C., the melt-down temperature of the non-woven fabric can be set to 150° C. or more.

The non-woven fabric is desirably made of at least one selected from the group consisting of polypropylene, polyamide, polyimide and polyethylene terephthalate. They may be used singly or in combination of two or more of them. Since these materials have high melting points and high thermal stabilities, they are unlikely to melt or deform even at high temperatures. Also, the melting of the separator is unlikely to occur even at high temperatures. Therefore, in a battery after high temperature storage, degradation of battery characteristics due to clogging of the separator is unlikely to occur.

The structures of the positive electrode and the negative electrode are described below.

The positive electrode typically includes a positive electrode active material comprising a composite lithium oxide, a positive electrode binder, and a conductive agent.

Preferable exemplary composite lithium oxides include lithium cobaltate (LiCoO₂), modified lithium cobaltate, lithium nickelate (LiNiO₂), modified lithium nickelate, lithium manganate (LiMn₂O₄), modified lithium manganate, and these oxides in which a part of Co, Mn or Ni is replaced with another transition metal element. Some of the modified ones include an element such as aluminum or magnesium. Also, some include at least two of cobalt, nickel and manganese. Mn-type lithium-containing transition metal oxides, such as LiMn₂O₄. are particularly promising in that they are abundant on the Earth and inexpensive.

With respect to the positive electrode binder, there is no particular limitation, and usable examples include polytetrafluoroethylene (PTFE), modified acrylonitrile rubber particles (e.g., BM-500B available from Zeon Corporation), and polyvinylidene fluoride (PVDF). It is preferred to use PTFE or BM-500B in combination with a thickener of the raw material paste for the positive electrode mixture layer, such as CMC, polyethylene oxide (PEO), or modified acrylonitrile rubber (e.g., BM-720H available from Zeon Corporation). PVDF alone has the function of the positive electrode binder and the function of the thickener.

As the conductive agent, acetylene black, ketjen black, various graphites, and the like may be used. They may be used singly or in combination of two or more of them.

The negative electrode typically includes a negative electrode active material comprising a material capable of absorbing and desorbing lithium ions, a negative electrode binder, and a thickener.

Exemplary negative electrode active materials include carbon materials such as various natural graphites, various artificial graphites, petroleum coke, carbon fibers, and baked organic polymers, oxides, silicon-containing composite materials such as silicide, various metals and alloy materials.

With respect to the negative electrode binder, there is no particular limitation, and PTFE, modified acrylonitrile rubber particles, PVDF, CMC, or the like may be used similarly to the positive electrode binder. However, a rubber-like polymer is preferably used. As the rubber-like polymer, one having a styrene unit and a butadiene unit is preferably used. For example, a styrene-butadiene copolymer (SBR), modified SBR, or the like is used, but there is no limitation to these.

For the non-aqueous electrolyte, the use of a non-aqueous solvent dissolving a lithium salt as a solute is preferable. As the lithium salt, lithium hexafluorophosphate (LiPF₆), lithium perchlorate (LiClO₄), lithium fluoroborate (LiBF₄), or the like is preferably used. As the non-aqueous solvent, ethylene carbonate (EC), propylene carbonate (PC), dimethyl carbonate (DMC), diethyl carbonate (DEC), methyl ethyl carbonate (MEC), or the like is preferably used. These non-aqueous solvents may be used singly, but the use of a combination of two or more of them is preferable. The concentration of the solute dissolved in the non-aqueous solvent is generally 0.5 to 2 mol/L.

In order to form a favorable film on the positive electrode and/or the negative electrode and ensure, for example, stability upon overcharge, vinylene carbonate (VC), cyclohexyl benzene (CHB), modified VC, modified CHB, or the like may also be used.

The present invention is hereinafter described more specifically by way of examples. These examples, however, are not to be construed as limiting in any way the present invention.

### COMPARATIVE EXAMPLE 1

(i) Positive Electrode Production

3 kg of lithium cobaltate (LiCoO₂) was mixed with 1 kg of #1320 (N-methyl-2-pyrrolidone (NMP) solution containing 12% by weight of PVDF) available from Kureha Chemical Industry Co., Ltd., 90 g of acetylene black serving as a conductive agent, and a suitable amount of NMP. The mixture was kneaded by a double-arm kneader, to prepare a positive electrode mixture paste. The resultant positive electrode mixture paste was applied onto both sides of a 15-μm-thick aluminum foil (positive electrode current collector), dried, and rolled to form positive electrode mixture layers. The total thickness of the current collector and the positive electrode mixture layers carried on both sides thereof was 160 μm. Thereafter, this was slit to a width such that it could be inserted into a cylindrical battery case of size 18650, to obtain a belt-like positive electrode hoop.

(ii) Negative Electrode Production

3 kg of artificial graphite was mixed with 75 g of BM-400B (water dispersion containing 40% by weight of rubber particles comprising styrene-butadiene copolymer) available from Zeon Corporation, 30 g of carboxymethyl cellulose (CMC), and a suitable amount of water. The mixture was kneaded by a double-arm kneader, to prepare a negative electrode mixture paste. The resultant negative electrode mixture paste was applied onto both sides of a 10-μm-thick copper foil (negative electrode current collector), dried, and rolled to form negative electrode mixture layers. The total thickness of the current collector and the negative electrode mixture layers carried on both sides thereof was 180 μm. Thereafter, this was slit to a width such that it could be inserted into a cylindrical battery case of size 18650, to obtain a belt-like negative electrode hoop.

(iii) Non-Aqueous Electrolyte Preparation

The non-aqueous electrolyte used was prepared by dissolving lithium hexafluorophosphate (LiPF₆) at a concentration of 1 mol/liter in a solvent mixture of ethylene carbonate, ethyl methyl carbonate and dimethyl carbonate in a volume ratio of 1:1:1. Also, 3% by weight of vinylene carbonate was added to the non-aqueous electrolyte.

(iv) Battery Assembly

From the above-mentioned positive electrode hoop and negative electrode hoop, a positive electrode and a negative electrode, each having a predetermined length, were cut. The positive electrode and the negative electrode were then wound with a separator made of a 20-μm-thick polypropylene non-woven fabric and inserted into the battery case.

The separator made of a 20-μm-thick polypropylene non-woven fabric used was prepared by rolling P010SW-00X (Grade name) available from Tapyrus Co., Ltd. to a thickness of 20 μm. The density (Basis Weight) of P010SW-00X is 10 g/m².

Subsequently, 5.5 g of the above-mentioned non-aqueous electrolyte was injected into the battery case, and the opening of the case was sealed. In this way, a cylindrical lithium secondary battery of size 18650 was produced.

The melt-down temperature of the above-mentioned non-woven fabric was measured in the following manner.

The same positive electrode, negative electrode and separator (non-woven fabric) as those described above, which were prepared separately, were punched into discs having diameters of 15 mm, 16 mm and 17 mm, respectively. Using them, a coin-type battery of size 2016 was produced. After this battery was charged up to 4.2 V, it was heated at 0.5° C./min, and the temperature at which a sharp voltage drop occurred was measured. This temperature was designated as the melt-down temperature. The melt-down temperature of the non-woven fabric measured in the above-described conditions was 175° C.

### COMPARATIVE EXAMPLE 2

A cylindrical lithium secondary battery of size 18650 was produced in the same manner as in Comparative Example 1, except for the use of a polyethylene microporous film (thickness 20 μm, Hipore available from Asahi Kasei Corporation) instead of the 20-μm-thick polypropylene non-woven fabric.

The melt-down temperature of the microporous film was measured in the same manner as that of the non-woven fabric of Comparative Example 1, and it was found to be 140° C.

### COMPARATIVE EXAMPLE 3

A cylindrical lithium secondary battery of size 18650 was produced in the same manner as in Comparative Example 1 except for the following operations.

970 g of alumina with a median diameter of 0.3 μm serving as an inorganic oxide filler, 375 g of BM-720H (NMP solution containing 8% by weight of a polymer having an acrylonitrile group) available from Zeon Corporation, and a suitable amount of NMP were stirred by a double-arm kneader, to form a paste of raw materials for a porous film. This raw material paste was applied onto both sides of a 20-μm-thick polypropylene non-woven fabric and dried, to form a porous film adhered to each side of the non-woven fabric. The thickness of the porous film on one side of the non-woven fabric was made 5 μm, and the total thickness of the non-woven fabric and the porous films on both sides thereof was made 30 μm.

The content (% by weight) of the inorganic filler in the porous film is as follows:
{970/(970+375×0.08)}×100=(970/1000)×100=97% by weight

### COMPARATIVE EXAMPLE 4

A cylindrical lithium secondary battery of size 18650 was produced in the same manner as in Comparative Example 1 except for the following operations.

The same raw material paste for a porous film as that of Comparative Example 3 was applied onto both sides of a negative electrode hoop and dried, to form a porous film adhered to each side of the negative electrode hoop. The thickness of the porous film on one side of the negative electrode hoop was made 5 μm, and the total thickness of the negative electrode hoop and the porous films carried on both sides thereof was made 190 μm.

Also, the same polyethylene microporous film (thickness 20 μm) as that of Comparative Example 2 was used instead of the 20-μm-thick polypropylene non-woven fabric.

### EXAMPLE 1

A cylindrical lithium secondary battery of size 18650 was produced in the same manner as in Comparative Example 1 except for the following operations.

The same raw material paste for a porous film as that of Comparative Example 3 was applied onto both sides of a positive electrode hoop and dried, to form a porous film adhered to each side of the positive electrode hoop. The thickness of the porous film on one side of the positive electrode hoop was made 5 μm, and the total thickness of the positive electrode hoop and the porous films carried on both sides thereof was made 170 μm.

### EXAMPLES 2 TO 8

Cylindrical lithium secondary batteries of size 18650 were produced in the same manner as in Comparative Example 1, except for the following operations.

The same raw material paste for a porous film as that of Comparative Example 3 was applied onto both sides of a negative electrode hoop and dried, to form a porous film adhered to each side of the negative electrode hoop.

A battery in which the thickness of the porous film on one side of the positive electrode was 0.3 μm and the total thickness of the positive electrode and the porous films carried on both sides thereof was 160.6 μm was designated as Example 2.

A battery in which the thickness of the porous film on one side of the positive electrode was 0.5 μm and the total thickness of the positive electrode and the porous films carried on both sides thereof was 161 μm was designated as Example 3.

A battery in which the thickness of the porous film on one side of the positive electrode was 1 μm and the total thickness of the positive electrode and the porous films carried on both sides thereof was 162 μm was designated as Example 4.

A battery in which the thickness of the porous film on one side of the positive electrode was 5 μm and the total thickness of the positive electrode and the porous films carried on both sides thereof was 170 μm was designated as Example 5.

A battery in which the thickness of the porous film on one side of the positive electrode was 10 μm and the total thickness of the positive electrode and the porous films carried on both sides thereof was 180 μm was designated as Example 6.

A battery in which the thickness of the porous film on one side of the positive electrode was 20 μm and the total thickness of the positive electrode and the porous films carried on both sides thereof was 200 μm was designated as Example 7.

A battery in which the thickness of the porous film on one side of the positive electrode was 30 μm and the total thickness of the positive electrode and the porous films carried on both sides thereof was 220 μm was designated as Example 8.

### EXAMPLES 9 TO 15

Cylindrical lithium secondary batteries of size 18650 were produced in the same manner as in Example 5, except for the use of polypropylene non-woven fabrics having the following thicknesses instead of the 20-μm-thick polypropylene non-woven fabric. The thicknesses of the non-woven fabrics were adjusted by varying the rolling condition of P010SW-00X.

A battery using a 10-μm-thick polypropylene non-woven fabric was designated as Example 9.

A battery using a 15-μm-thick polypropylene non-woven fabric was designated as Example 10.

A battery using a 25-μm-thick polypropylene non-woven fabric was designated as Example 11.

A battery using a 30-μm-thick polypropylene non-woven fabric was designated as Example 12.

A battery using a 40-μm-thick polypropylene non-woven fabric was designated as Example 13.

A battery using a 50-μm-thick polypropylene non-woven fabric was designated as Example 14.

A battery using a 60-μm-thick polypropylene non-woven fabric was designated as Example 15.

### EXAMPLES 16 TO 22

Cylindrical lithium secondary batteries of size 18650 were produced in the same manner as in Example 5, except that the content (% by weight) of the inorganic oxide filler (alumina) in the porous film was varied as listed in Table 1.

A battery with an inorganic oxide filler content of 30% by weight was designated as Example 16.

A battery with an inorganic oxide filler content of 50% by weight was designated as Example 17.

A battery with an inorganic oxide filler content of 70% by weight was designated as Example 18.

A battery with an inorganic oxide filler content of 90% by weight was designated as Example 19.

A battery with an inorganic oxide filler content of 95% by weight was designated as Example 20.

A battery with an inorganic oxide filler content of 99% by weight was designated as Example 21.

A battery with an inorganic oxide filler content of 99.5% by weight was designated as Example 22.

### EXAMPLE 23

A cylindrical lithium secondary battery of size 18650 was produced in the same manner as in Example 5, except for the use of titania with a median diameter of 0.3 μm as the inorganic oxide filler, instead of alumina with a median diameter of 0.3 μm, in the preparation of a raw material paste for a porous film.

### COMPARATIVE EXAMPLE 5

A cylindrical lithium secondary battery of size 18650 was produced in the same manner as in Example 5, except for the use of polyethylene beads with a median diameter of 0.3 μm, instead of alumina with a median diameter of 0.3 μm as the inorganic oxide filler, in the preparation of a raw material paste for a porous film.

### EXAMPLE 24

A cylindrical lithium secondary battery of size 18650 was produced in the same manner as in Example 5, except for the use of non-woven fabric comprising polypropylene fibers and polyamide fibers in a weight ratio of 1:1, instead of the 20-μm-thick polypropylene non-woven fabric. The density of the non-woven fabric was made the same as that of Comparative Example 1 (Example 5).

The melt-down temperature of the non-woven fabric used in this example was measured in the same manner as that of the non-woven fabric of Comparative Example 1, and it was found to be 205° C..

Table 1 shows the main structures of the porous films and the separators in the above-described Examples and Comparative Examples.

TABLE 1

| | Porous film | | | | Separator | | |
|---|---|---|---|---|---|---|---|
| | | | Filler | | | | Melt-down |
| | Location | Thickness | | Content | Thickness | | temperature |
| Example No. | adhered | (μm) | Kind | (wt %) | (μm) | Kind | (° C.) |
| 1 | Positive | 5 | Alumina | 97 | 20 | PP non-woven | 175 |
| | electrode | | | | | fabric | |
| 2 | Negative | 0.3 | Alumina | 97 | 20 | PP non-woven | 175 |
| | electrode | | | | | fabric | |
| 3 | Negative | 0.5 | Alumina | 97 | 20 | PP non-woven | 175 |
| | electrode | | | | | fabric | |
| 4 | Negative | 1 | Alumina | 97 | 20 | PP non-woven | 175 |
| | electrode | | | | | fabric | |
| 5 | Negative | 5 | Alumina | 97 | 20 | PP non-woven | 175 |
| | electrode | | | | | fabric | |
| 6 | Negative | 10 | Alumina | 97 | 20 | PP non-woven | 175 |
| | electrode | | | | | fabric | |
| 7 | Negative | 20 | Alumina | 97 | 20 | PP non-woven | 175 |
| | electrode | | | | | fabric | |
| 8 | Negative | 30 | Alumina | 97 | 20 | PP non-woven | 175 |
| | electrode | | | | | fabric | |
| 9 | Negative | 5 | Alumina | 97 | 10 | PP non-woven | 175 |
| | electrode | | | | | fabric | |
| 10 | Negative | 5 | Alumina | 97 | 15 | PP non-woven | 175 |
| | electrode | | | | | fabric | |
| 11 | Negative | 5 | Alumina | 97 | 25 | PP non-woven | 175 |
| | electrode | | | | | fabric | |
| 12 | Negative | 5 | Alumina | 97 | 30 | PP non-woven | 175 |
| | electrode | | | | | fabric | |
| 13 | Negative | 5 | Alumina | 97 | 40 | PP non-woven | 175 |
| | electrode | | | | | fabric | |
| 14 | Negative | 5 | Alumina | 97 | 50 | PP non-woven | 175 |
| | electrode | | | | | fabric | |
| 15 | Negative | 5 | Alumina | 97 | 60 | PP non-woven | 175 |
| | electrode | | | | | fabric | |
| 16 | Negative | 5 | Alumina | 30 | 20 | PP non-woven | 175 |
| | electrode | | | | | fabric | |
| 17 | Negative | 5 | Alumina | 50 | 20 | PP non-woven | 175 |
| | electrode | | | | | fabric | |
| 18 | Negative | 5 | Alumina | 70 | 20 | PP non-woven | 175 |
| | electrode | | | | | fabric | |
| 19 | Negative | 5 | Alumina | 90 | 20 | PP non-woven | 175 |
| | electrode | | | | | fabric | |
| 20 | Negative | 5 | Alumina | 95 | 20 | PP non-woven | 175 |
| | electrode | | | | | fabric | |
| 21 | Negative | 5 | Alumina | 99 | 20 | PP non-woven | 175 |
| | electrode | | | | | fabric | |
| 22 | Negative | 5 | Alumina | 99.5 | 20 | PP non-woven | 175 |
| | electrode | | | | | fabric | |
| 23 | Negative | 5 | Titania | 97 | 20 | PP non-woven | 175 |
| | electrode | | | | | fabric | |
| 24 | Negative | 5 | Alumina | 97 | 20 | PP-PA non-woven | 205 |
| | electrode | | | | | fabric | |
| Comparative | None | — | — | — | 20 | PP non-woven | 175 |
| Example 1 | | | | | | fabric | |
| Comparative | None | — | — | — | 20 | PE film | 140 |
| Example 2 | | | | | | | |
| Comparative | Separator | 5 | Alumina | 97 | 20 | PP non-woven | 175 |
| Example 3 | | | | | | fabric | |
| Comparative | Negative | 5 | Alumina | 97 | 20 | PE film | 140 |
| Example 4 | electrode | | | | | | |
| Comparative | Negative | 5 | PE beads | 97 | 20 | PP non-woven | 175 |
| Example 5 | electrode | | | | | fabric | |

PE beads: Polyethylene beads,
PP non-woven fabric: Polypropylene non-woven fabric,
PP-PA non-woven fabric: Polypropylene-polyamide non-woven fabric,
PE film: Polyethylene micro-porous film

The batteries of the above-mentioned Examples and Comparative Examples were evaluated in the following manner. Table 2 shows the results.

(Defective Rate)

Of each of the Examples and Comparative Examples, 10 electrode groups were assembled by the operation of winding a positive electrode and a negative electrode around a winding core with a separator interposed therebetween. Thereafter, they were unwound, and the states of their porous films mainly near the winding core were visually observed. Table 2 shows the number of workpieces that were short-circuited due to breakage, cracking or falling-off of the porous films.

(Battery Design Capacity)

As compared with the diameter of the battery case being 18 mm, the diameter of the wound electrode group was made 16.5 mm for ease of insertion. In this case, provided that the capacity per 1 g of the positive electrode active material is 142 mAh, the battery design capacity was obtained from the positive electrode weight. Table 2 shows the obtained values.

(Charge/Discharge Characteristics)

Completed batteries with electrode groups having no breakage, cracking or falling-off of the porous films were subjected to a preliminary charge/discharge twice and stored in a 45° C. environment for 7 days. Thereafter, in a 20° C. environment, they were subjected to charge/discharge according to the following 2 patterns each for 1 cycle. Table 2 shows the discharge capacities obtained from the respective cycles.

(1) First pattern

Constant current charge: 1400 mA (cut-off voltage 4.2 V)

Constant voltage charge: 4.2 V (cut-off current 100 mA)

Constant current discharge: 400 mA (cut-off voltage 3 V)

(2) Second pattern

Constant current charge: 1400 mA (cut-off voltage 4.2 V)

Constant voltage charge: 4.2 V (Cut-off current 100 mA)

Constant current discharge: 4000 mA (cut-off voltage 3 V)

(Cycle Characteristics)

After the evaluation of charge/discharge characteristics, the batteries were repeatedly charged and discharged in a 20° C. environment according to the following pattern, and the ratio of the discharge capacity at the 300th cycle to the initial discharge capacity was obtained. Table 2 shows the ratios expressed as percentages as the capacity retention rates.

Constant current charge: 1400 mA (cut-off voltage 4.2 V)

Constant voltage charge: 4.2 V (cut-off current 100 mA)

Constant current discharge: 2000 mA (cut-off voltage 3 V)

(Nail Penetration Safety)

After the evaluation of charge/discharge characteristics, the batteries were charged in a 20° C. environment in the following manner.

Constant current charge: 1400 mA (cut-off voltage 4.25 V)

Constant voltage charge: 4.25 V (cut-off current 100 mA)

A 2.7-mm-diameter round nail made of iron was caused to penetrate the charged batteries from their side faces in a 20′ environment at a speed of 5 mm/sec or 180 mm/sec, and the heat generation was observed. Table 2 shows the temperatures of the penetrated parts of the batteries after 1 second and 90 seconds.

(High Temperature Safety)

After the evaluation of charge/discharge characteristics, the batteries were charged in a 20° C. environment in the following manner.

Constant current charge: 1400 mA (cut-off voltage 4.25 V)

Constant voltage charge: 4.25 V (cut-off current 100 mA)

The charged batteries were heated to 150° C. at a temperature increase rate of 5° C./min, and allowed to stand at 150° C. for 3 hours. Subsequently, the batteries were measured for their voltages and surface temperatures. Table 2 shows the results.

TABLE 2

| | | | Charge/ | | | | | | | | |
|---|---|---|---|---|---|---|---|---|---|---|---|
| | | | discharge | | Cycle | | | | | | |
| | | | characteristics | | characteristics | Nail penetration safety | | | | | |
| | | | Discharge | | Capacity | Nail speed | | Nail speed | | High temperature | |
| | | | capacity | | retention | (5 mm/s) | | (180 mm/s) | | safety | |
| | Defective | Design | (mAh) | | rate (%) | After | After | After | After | Surface | |
| | rate | capacity | 400 | 4000 | 300 | 1 s | 90 s | 1 s | 90 s | temperature | Voltage |
| Example No. | (%) | (mAh) | mA | mA | cycles | (° C.) | (° C.) | (° C.) | (° C.) | (° C.) | (V) |
| 1 | 0 | 2011 | 2010 | 1819 | 94 | 72 | 91 | 70 | 88 | 152 | 4.1 |
| 2 | 0 | 2010 | 2008 | 1887 | 94 | 78 | 139 | 77 | 136 | 163 | 3.5 |
| 3 | 0 | 2021 | 2020 | 1879 | 94 | 76 | 89 | 69 | 93 | 152 | 4.1 |
| 4 | 0 | 2070 | 2069 | 1895 | 95 | 71 | 92 | 74 | 94 | 151 | 4.1 |
| 5 | 0 | 2015 | 2012 | 1821 | 95 | 74 | 94 | 72 | 89 | 152 | 4.2 |
| 6 | 0 | 1890 | 1883 | 1759 | 94 | 68 | 88 | 76 | 90 | 151 | 4.2 |
| 7 | 0 | 1729 | 1728 | 1545 | 93 | 77 | 90 | 70 | 91 | 151 | 4.1 |
| 8 | 3 | 1684 | 1682 | 1470 | 93 | 73 | 94 | 75 | 96 | 151 | 4.1 |
| 9 | 0 | 2094 | 2086 | 1962 | 91 | 70 | 97 | 74 | 95 | 152 | 4.0 |
| 10 | 0 | 2020 | 2012 | 1871 | 93 | 71 | 91 | 73 | 94 | 151 | 4.1 |
| 11 | 0 | 1968 | 1965 | 1827 | 93 | 71 | 90 | 73 | 94 | 151 | 4.1 |
| 12 | 0 | 1800 | 1792 | 1654 | 94 | 71 | 89 | 73 | 94 | 151 | 4.1 |
| 13 | 0 | 1656 | 1649 | 1488 | 93 | 70 | 87 | 71 | 90 | 151 | 4.1 |
| 14 | 0 | 1520 | 1509 | 1312 | 93 | 70 | 87 | 71 | 91 | 151 | 4.1 |
| 15 | 0 | 1380 | 1371 | 998 | 91 | 70 | 86 | 70 | 90 | 151 | 4.1 |
| 16 | 0 | 2017 | 1822 | 1472 | 93 | 71 | 95 | 73 | 94 | 151 | 4.1 |
| 17 | 0 | 2016 | 1961 | 1737 | 93 | 66 | 88 | 69 | 91 | 151 | 4.1 |
| 18 | 0 | 2015 | 1989 | 1811 | 94 | 70 | 96 | 72 | 89 | 151 | 4.1 |
| 19 | 0 | 2017 | 2015 | 1893 | 94 | 70 | 94 | 68 | 89 | 151 | 4.1 |
| 20 | 0 | 2014 | 2009 | 1883 | 93 | 73 | 91 | 73 | 88 | 151 | 4.1 |
| 21 | 1 | 2015 | 2010 | 1886 | 93 | 69 | 88 | 74 | 92 | 151 | 4.1 |
| 22 | 6 | 2015 | 2010 | 1890 | 91 | 72 | 90 | 75 | 90 | 151 | 4.1 |
| 23 | 0 | 2014 | 2005 | 1880 | 92 | 72 | 90 | 71 | 93 | 152 | 4.1 |
| 24 | 0 | 2015 | 2011 | 1889 | 93 | 65 | 93 | 72 | 95 | 151 | 4.2 |
| Comparative | 18 | 2017 | 2012 | 1971 | 95 | 139 | — | 135 | — | 165 | 2.5 |
| Example 1 | | | | | | | | | | | |
| Comparative | 0 | 2015 | 2003 | 1888 | 90 | 146 | — | 138 | — | 170 | 0 |
| Example 2 | | | | | | | | | | | |
| Comparative | 0 | 1944 | 1935 | 1812 | 94 | 81 | 151 | 69 | 93 | 168 | 2.8 |
| Example 3 | | | | | | | | | | | |
| Comparative | 0 | 2010 | 2008 | 1789 | 88 | 80 | 149 | 77 | 91 | 160 | 3.9 |
| Example 4 | | | | | | | | | | | |
| Comparative | 0 | 2014 | 2014 | 1901 | 95 | 146 | — | 142 | — | 160 | 3.8 |
| Example 5 | | | | | | | | | | | |

The evaluation results are given below.

(1) With Respect to Presence or Absence of Porous Film

In the comparative examples having no porous film, the heat generation after 1 second is remarkable regardless of the nail penetration speed. In contrast, in the examples with the porous films formed on the positive electrode or the negative electrode, the heat generation after the nail penetration is significantly suppressed.

All the batteries after the nail penetration tests were disassembled and examined, and it was found that the separators of all the batteries were melted in large areas thereof. However, in the examples, their porous films retained the original forms. This indicates that the porous films are not destroyed by the heat generated after the nail penetration and serve to suppress expansion of a short-circuit and prevent excessive heat generation.

Also, in the high temperature safety evaluations, in the comparative examples having no porous film, their battery temperatures are high due to short-circuits caused by separator shrinkage. Further, among the comparative examples having no porous film, the battery using non-woven fabric as the separator has a high defective rate. This indicates that internal short-circuits are apt to occur in a manufacturing process. This suggests that it is difficult to produce a battery by using non-woven fabric alone as the separator without using a porous film.

(2) With Respect to Porous Film Location

It can be seen that in the comparative example in which the porous films are adhered to the separator surfaces, the heat generation is promoted when the nail penetration speed is slow. The battery of this comparative example was disassembled and examined, and it was confirmed that the porous films were also deformed due to the above-mentioned melting of the separator. The reason of breakage of the porous films is probably that upon the shrinkage or melting of the separator to which the porous films were adhered, the porous films are affected by the change of separator shape in spite of the heat resistance of the porous films themselves. It is considered that for the same reason, a short-circuit occurred and the battery temperature increased in the high temperature safety evaluation.

(3) With Respect to the Kind of Separator

Since the use of non-woven fabric as the separator usually increases the defective rate, it is common sense for one with ordinary skill in the art to use a microporous film. However, if non-woven fabric is used in combination with a porous film adhered to an electrode surface, the defective rate is suppressed to such a large extent that one with ordinary skill in the art cannot predict. Moreover, the use of non-woven fabric as the separator improves the charge/discharge characteristics and cycle characteristics of the batteries more than the use of a microporous film. This is probably because the presence of non-woven fabric makes the movement of the electrolyte inside the battery smooth.

In Tables 1 and 2, the examples using the polypropylene non-woven fabric exhibit improved cycle characteristics, in comparison with the comparative examples in which the porous films are adhered to the negative electrode surfaces and the polyethylene microporous film was used as the separator. This is probably because the high electrolyte-retaining ability of non-woven fabric in comparison with the polyolefin-type microporous film suppressed electrolyte shortage upon charges and discharges.

Further, the use of non-woven fabric results in a higher safety than the use of the microporous film. This is probably because non-woven fabric is usually less likely to deform than a microporous film upon a battery short-circuit. Particularly when polypropylene is used as the material of non-woven fabric, even if the battery temperature is increased to 150° C., the non-woven fabric does not shrink due to heat. For this reason, it is thought that a short-circuit caused by distortion of the electrode group does not occur. It is considered that the use of a combination of polyamide and polypropylene as the material of non-woven fabric further improves heat resistance.

(4) With Respect to Nail Penetration Test

When nail penetration causes the positive electrode and the negative electrode to contact (short-circuit), Joule's heat is produced. The Joule's heat melts the material having a low heat resistance (separator), forming a strong short-circuit. As a result, Joule's heat is continuously produced, so that the battery is heated to a temperature range in which the positive electrode is thermally unstable (160° C. or higher). This causes heat runaway. Generally, when the nail penetration speed is reduced, local heat generation is promoted. When the nail penetration speed is reduced to limit the short-circuit area per unit time, a considerable amount of heat is concentrated at the limited portion. Therefore, it is considered that the temperature region in which the positive electrode is thermally unstable is reached in a shorter period of time. On the other hand, when the nail penetration speed is increased to enlarge the short-circuit area per unit time, heat is dispersed to a larger area. Therefore, it is considered that the temperature range in which the positive electrode is thermally unstable is unlikely to be reached.

In contrast to the above-mentioned general tendency, in the examples using a combination of the non-woven fabric and the porous film, the heat runaway is suppressed regardless of the nail penetration speed. Therefore, it can be said that the present invention has very high practical utility.

(5) With Respect to Porous Film Thickness

If the porous film is too thick, the length of the electrodes constituting the electrode group decreases, which leads to a decrease in design capacity and high-rate discharge capacity. On the other hand, if the porous film is too thin, the effect of suppressing heat generation decreases. Therefore, to obtain sufficient effects of the present invention, the thickness of the porous film is desirably 0.5 to 20 μm.

(6) With Respect to Separator Thickness

If the separator is too thick, the length of the electrodes constituting the electrode group decreases, which leads to a decrease in design capacity and high-rate discharge capacity. On the other hand, if the separator is too thin, the effect of improving the electrolyte-retaining ability is small, and the effect of improving cycle characteristics is also small. Therefore, to obtain sufficient effects of the present invention, the thickness of the separator is desirably 15 to 50 μm.

(7) With Respect to Inorganic Filler Content in Porous Film

In the examples in which the content of the inorganic filler is small relative to the total of the inorganic filler and the binder (the content of the binder is large), a capacity decline is found at the high rate discharge. This is probably because the excessive binder decreases the pores among the filler particles, thereby resulting in a decrease in the ionic conductivity of the porous film. However, if the content of the inorganic filler is excessive, the defective rate tends to rise. Therefore, to obtain sufficient effects of the present invention, the content of the inorganic filler is desirably 50 to 99% by weight.

(8) With Respect to Kind of Binder in Porous Film

In comparison with the use of CMC or PVDF as the binder, the use of a polymer having an acrylonitrile group as the binder produces a larger effect in suppressing the heat generated when the nail penetration speed is reduced. It is thought that a polymer having an acrylonitrile group hardly deforms even at high temperatures, since it is amorphous and highly resistant to heat. In the examples in which the binder is a polymer having an acrylonitrile group, their defective rates are 0%, which indicates that the wound porous films maintain sufficient strength and function.

(9) With Respect to Kind of Filler

The example using titania as the inorganic filler in place of alumina confirmed that titania performed essentially the same functions as those of alumina. On the other hand, when an organic material, i.e., polyethylene beads (PE beads) were used as the filler, the nail penetration safety was equivalent to that when no porous film was used. Accordingly, it is considered that selecting an inorganic oxide as the filler is essential.

### INDUSTRIAL APPLICABILITY

The present invention is particularly useful in providing a high-performance lithium secondary battery requiring both excellent safety and charge/discharge characteristics. Specifically, the present invention is applied to a lithium secondary battery with an excellent cycle life, which includes: a positive electrode comprising a composite lithium oxide; a negative electrode comprising a material capable of absorbing and desorbing lithium; a separator interposed between the positive electrode and the negative electrode, the separator comprising non-woven fabric; and a non-aqueous electrolyte. Since the lithium secondary battery of the present invention provides high safety, it is particularly useful as the power source for portable appliances.

1. A lithium secondary battery comprising: a positive electrode comprising a composite lithium oxide; a negative electrode comprising a material capable of absorbing and desorbing lithium; a separator interposed between said positive electrode and said negative electrode; and a non-aqueous electrolyte,
wherein said separator comprises non-woven fabric, at least one of said positive electrode and said negative electrode has a porous film that is adhered to a surface thereof, and said porous film comprises an inorganic oxide filler and a binder.

2. The lithium secondary battery in accordance with claim 1, wherein said non-woven fabric has a thickness of not less than 15 μm and not more than 50 μm.

3. The lithium secondary battery in accordance with claim 1, wherein said non-woven fabric has a melt-down temperature of 150° C. or more.

4. The lithium secondary battery in accordance with claim 1, wherein said non-woven fabric comprises at least one selected from the group consisting of polypropylene, polyamide, polyimide, and polyethylene terephthalate.

5. The lithium secondary battery in accordance with claim 1, wherein said porous film has a thickness of not less than 0.5 μm and not more than 20 μm.

6. The lithium secondary battery in accordance with claim 1, wherein said binder comprises at least a polymer having an acrylonitrile group.

7. The lithium secondary battery in accordance with claim 1, wherein said filler comprises alumina, and the content of said filler in said porous film is not less than 50% by weight and not more than 99% by weight.

8. The lithium secondary battery in accordance with claim 1, wherein said positive electrode and said negative electrode are wound with said separator interposed therebetween.
